(19) United States
(12) Patent Application Publication
(10) Pub. No.: US 2015/0371547 A1
(43) Pub. Date: Dec. 24, 2015

(54) PROVIDING TARGETED AND PERSONALIZED EDUCATION TO PREVENT HUMAN ERRORS

(71) Applicant: International Business Machines Corporation, Armonk, NY (US)

(72) Inventors: Milton H. Hernandez, Tenafly, NJ (US); Vugranam C. Sreedhar, Yorktown Heights, NY (US); Maja Vukovic, New York, NY (US)

(21) Appl. No.: 14/309,394

(22) Filed: Jun. 19, 2014

(51) Int. Cl. G09B 5/12; G09B 7/00; H04L 29/06; G06N 5/02; H04L 29/08

(52) U.S. Cl. CPC G09B 5/12; G06N 5/02; H04L 67/10; H04L 67/42; G09B 7/00

(57) ABSTRACT

An embodiment comprises a method associated with a computer system activity comprising one or more tasks, carried out by one or more users. The method comprises the step of furnishing a knowledge database with one or more knowledge teachings, wherein each knowledge teaching corresponds to one of the tasks. The method further comprises implementing a procedure at selected intervals, to determine whether any user in a group of users lacks specified knowledge related to one of the tasks. Responsive to determining that a particular user lacks specified knowledge related to a particular task, a knowledge teaching is presented to the particular user which corresponds to the particular task, and includes at least some of the specified knowledge which the particular user has been determined to lack. Feedback sent from the particular user, in response to receiving the presented knowledge teaching, is then selectively evaluated.

### BACKGROUND

1. Field

The invention disclosed and claimed herein pertains to a method and system for preventing, or significantly reducing, human errors in a computer related activity or system, such as an IT Service Delivery System by way of example. However, embodiments of the invention are not limited to such example.

2. Description of the Related Art

One of the biggest problems in a services industry is preventing human errors. Frequently, human errors occur due to a lack of domain knowledge for which the service is being delivered. For instance, in IT Service Delivery a person may delete a file during clean-up, in order to achieve a goal of managing disk space. If a person lacks knowledge of the system, then deleting some files, such as operating system files, can lead to critical operational situations such as the computer not being able to restart, or the computer crashing.

One approach for educating a person to avoid such errors is to let him or her take a rigorous class that improves his or her job skills. Although this type of education can be critical, the knowledge acquired is typically not immediately applicable, or the person may forget the acquired knowledge. Another problem with a rigorous education program is that it can take a person away from his or her job, and thus cost more money. In addition, overwhelming a person with too much knowledge at a time can be distracting for that person.

### SUMMARY

To achieve the objective of preventing or reducing errors in a computer system or activity as described above, embodiments of the invention determine that a system user or other personnel lacks certain knowledge. More particularly, it is determined that the user lacks specified knowledge that is useful or even essential for correct and successful system operation. Responsive to detecting this lack of knowledge, the user is targeted to receive educational material that presents at least some of the specified knowledge in a concise and efficient manner. Embodiments of the invention thus provide low cost personalized education, and reduction of human errors. Further benefits include enhanced incentive for personal development.

An embodiment of the invention comprising a computer implemented method is associated with a computer system activity that comprises one or more tasks, wherein respective tasks are carried out by one or more users. The method comprises the step of furnishing a knowledge database with one or more knowledge teachings, wherein each knowledge teaching corresponds to one of the tasks. The method further comprises implementing a procedure at selected intervals, to determine whether any user in a group of users lacks specified knowledge which is related to one of the tasks. Responsive to determining that a particular user lacks specified knowledge related to a particular task, a knowledge teaching is presented to the particular user which corresponds to the particular task, and includes at least some of the specified knowledge which the particular user has been determined to lack. Feedback sent from the particular user, in response to receiving the presented knowledge teaching, is then selectively evaluated.

### BRIEF DESCRIPTION OF THE SEVERAL VIEWS OF THE DRAWINGS

FIG. 1 is a schematic diagram illustrating steps, features and aspects of an embodiment of the invention;

FIG. 2 is a flowchart showing steps of a method comprising an embodiment of the invention;

FIG. 3 is a block diagram showing components of an embodiment of the invention;

FIG. 4 is a block diagram showing a network of data processing systems in which an embodiment of the invention may be implemented; and

FIG. 5 is a block diagram showing a computer or data processing system that may be used in implementing embodiments of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

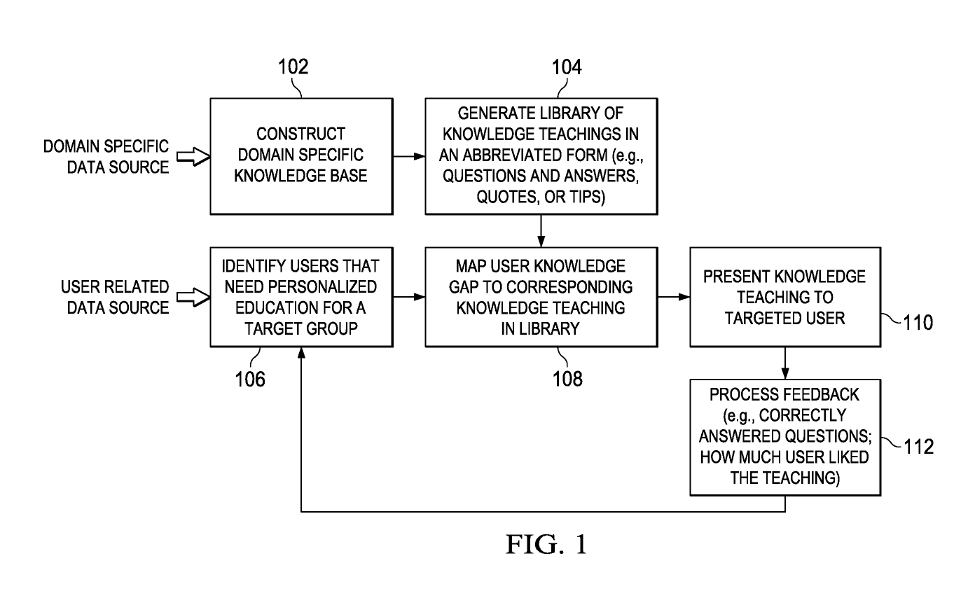

Referring to FIG. 1, there is shown a schematic diagram which illustrates steps, features, and aspects of an embodiment of the invention. As described above, embodiments seek to determine whether users who operate a computer system, and participate in selected system tasks or activities, lack certain knowledge needed for correct and successful system operation. A lack of knowledge of this type is also referred to herein as a knowledge gap, or deficiency. When a user having a knowledge gap is identified, an embodiment of the invention furnishes the user with educational material which is targeted and personalized to overcome the knowledge gap. To achieve this objective in part, the embodiment of FIG. 1 provides a database at step 102, which comprises a domain specific knowledge database.

The knowledge database of step 102 contains information pertaining to one or more specific domains, or different activities or tasks which may be carried out during operation of the computer system. Exemplary activities or tasks could include proper use of an ID and password to log onto a server or other system, operating a password generator and checker tool, and proper use of a Secure Shell (SSH) key. A further example could be proper installation of a corrective patch to specified software. However, embodiments of the invention are by no means limited to these examples or exemplary activities.

In order to construct the knowledge database of step 102, the system can use existing domain specific knowledge. This information can include, by way of example and not limitation, security and compliance policies, other policies and procedures, and problems resolved by users in the past, as shown by data sources such as prior user service tickets. The information may further include profiles of system personnel or other users, such as their blogs, resumes, and work experiences, wherein such users have successfully carried out a particular activity, action, or task in the past. The profile information for these users can then be employed to compute performance levels that are likely to achieve success in upcoming or future performance of the particular activity or task.

At step 104 of FIG. 1, knowledge teachings are generated in a brief or abbreviated form, and then placed in a database such as a library of knowledge teachings. More particularly, this step extracts knowledge items from the specific knowledge data base at step 102, wherein each knowledge item pertains to a particular aspect, activity, or concern of computer system operation. For example, some knowledge items could pertain to tools that are available to system users, such as password generator and checker tools, and their proper use. After acquiring respective knowledge items, step 104 arranges them into one or more brief presentations of information, which each comprises a knowledge teaching. Each such teaching may comprise a limited number of tips, or may comprise quotations of relevant information from the domain specific knowledge base. Alternatively, a knowledge teaching or presentation could be in the form of a limited number of multiple choice questions, for which answers are to be provided by a user. Respective teachings are placed into the library of step 104 in a systematic order, so that a particular knowledge teaching can be quickly found when needed.

At step 106, a target group of users, employees, or other personnel is identified, wherein the users or others participate in system operation. This identification is carried out by assessing the past history of respective users, as shown by data provided from a user related data source. Information from the data source can include, by way of example, previous user evaluations, records of user errors, and how respective users resolved problems, as shown by documents such as their prior service tickets. Users who are determined from such information to have knowledge gaps or deficiencies, in regard to specified activities or tasks relating to operation of the system, are identified for the group at step 106. Members of the group may then be targeted to receive personalized education material, in order to close or fill in the gaps.

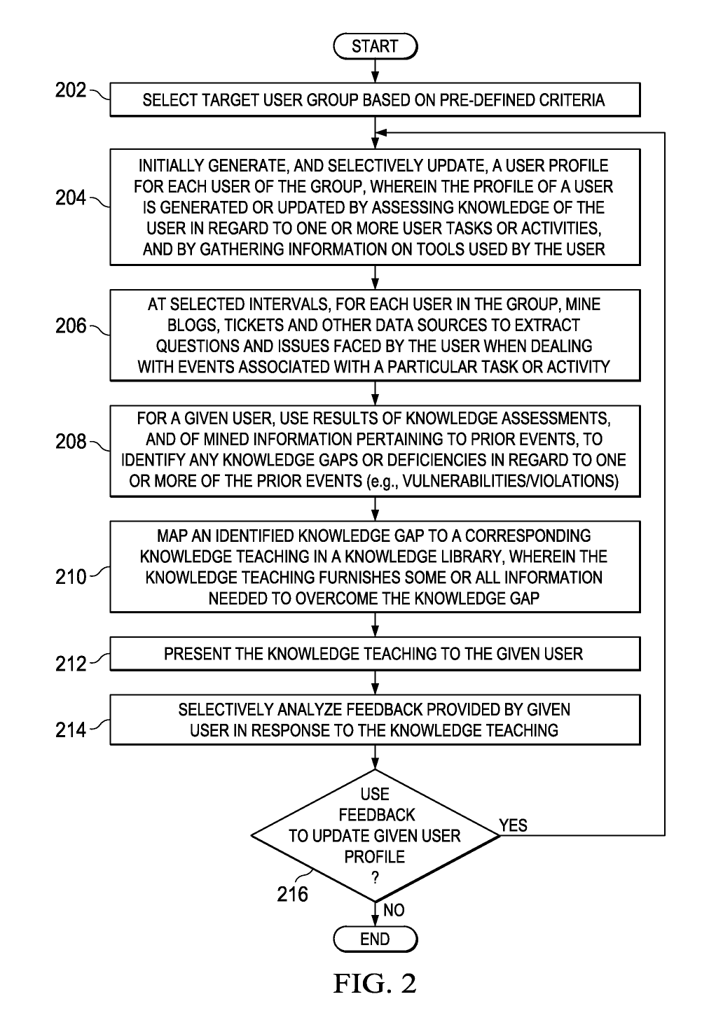

In one embodiment of the invention, users are selected for the target group of step 106 on the basis of predefined criteria. These criteria can include exceeding a specified number of user errors of some type, or exceeding a specified number of reopened or unresolved service tickets. A further exemplary criterion could be that a user is found to be in noncompliance with a specified policy. However, embodiments of the invention are not limited to these exemplary criteria. Selection or identification of users or other system related personnel for a target group, such as the group of step 106, is discussed hereinafter in further detail in connection with FIG. 2.

Referring to step 108 of FIG. 1, the knowledge gap of a given user identified at step 106 is mapped to a corresponding knowledge teaching, which is contained in the knowledge teaching library. The corresponding knowledge teaching is a teaching that is intended to furnish some or all of the information needed to overcome the knowledge gap of the given user. The mapping process is carried out by searching the knowledge teaching library until a teaching that corresponds to, or is most relevant to, the knowledge which the given user lacks is located.

As one example of the mapping process, it could have been determined that a user knowledge gap was a lack of knowledge of all the tools that were available to the user for use in system operation. In view of this deficiency, the mapping process would search the knowledge library to find a teaching for educating target group users about available system tools. As another example, the user knowledge gap could be a misunderstanding of certain system access password rules. For this lack of knowledge, the library would be searched to find a knowledge teaching which educated users about correct password rules or protocols. Also, for some knowledge gaps multiple knowledge teachings may be presented to a user.

At step 110 of FIG. 1, the knowledge teaching is presented to a target group user, wherein presentation could be made in a number of different ways. As described above, the teaching or presentation may comprise a limited number of tips, quotations, or multiple-choice questions to be answered by the target user. Usefully, one or two tips, or one or two questions to be answered, could be provided to the user at intervals such as once a week. Also, the subject matter of the tips or questions would usefully be directed to the work the user actually performs. It is anticipated that users receiving a teaching presentation as described above will be more willing to answer one or two questions a week, or read a quote and give feedback if they like or agree with what they receive. It is further anticipated that presentations as described above may significantly improve a user's abilities and skill sets over time.

For the above example of a knowledge gap in regard to system tools available to a user, an exemplary knowledge teaching could comprise questions for the user to answer, as to whether each of several tools on a list was or was not a system tool available for use by the user. The list could include both tools that were and were not available system tools for that user.

For the above example pertaining to password rules, an example of a knowledge teaching could comprise the tip that “system password rules must be followed when using your ID/password on our system or on a customer system, unless requirements for the customer system are more stringent”.

Feedback received from a user, in response to receiving a knowledge teaching presentation at step 110, is selectively processed at step 112. If the presentation included questions for the user, step 110 determines which of the user's answers were correct. It is also useful at step 112 to assess the user's attitude in regard to the knowledge teaching. For example, if the teaching presented first, second, and third tips of information, and the user felt that the third tip was much more important than the first and second tips, the presentation for future use might be revised to present the third tip first.

Results of processed feedback, such as the correctness of a user's answers to questions, may usefully be placed in a record of the user's profile. This information can then be used subsequently at step 106, if it again becomes necessary to determine whether or not the user should be placed in the target group.

Referring to FIG. 2, there are shown steps of a method that comprises an embodiment of the invention. As a first step 202, users of a specified computer system or the like are selected for a target user group, which is similar to the step 106 target group of FIG. 1. Usefully, selection of users for the group at step 202 is based upon one or more predefined or pre-specified criteria. These user criteria may include a specified number of previous user errors or unresolved service tickets, or user noncompliance of a specified rule or policy, all in like manner with step 106.

Step 204 initially generates, and may periodically update, a user profile for each user selected for the target group. The profile is generated for a user by assessing knowledge information which the user has, in regard to system tasks and activities which the user may engage in. The knowledge information more particularly may include user expertise in operating the system, tools used by the user, clients supported, and user knowledge of system compliance procedures. Further user knowledge status to consider could include previous unresolved service tickets of the user, and past server or system vulnerabilities that the user was responsible for. An example of this could be a previous failure of the user to install a software patch or the like, whereby a system server became vulnerable to attack.

Step 206 of FIG. 2 is carried out at selected intervals, for each user in the target group. At each interval, step 206 mines the blogs, tickets and other data sources of the user, in order to extract questions and issues faced by that user when dealing with events associated with a particular task or activity of the system.

Step 208 makes use of both results of the knowledge assessments of step 204, and the information mining of step 206. More particularly, step 208 uses these results to identify users of the target group that have knowledge gaps or deficiencies, as such term is defined and described above in connection with FIG. 1. For a given user that is identified to have a knowledge gap, the identified knowledge gap is mapped to a corresponding knowledge teaching in a knowledge library, at step 210. Thus, step 210 is similar or identical to step 108 of FIG. 1, and may carry out its function in the same manner. Moreover, the knowledge teachings of the library of step 210 may be similar to the knowledge teachings of the library of step 108. Accordingly, a knowledge teaching of step 210 could comprise a limited number of tips, quotations or questions to be answered by the given user, and would provide information related to a particular knowledge gap.

At step 212, the knowledge teaching mapped to the knowledge gap of a given user is presented to that user. If the given user provides feedback in response to receiving the presented knowledge teaching, the feedback is selectively analyzed at step 214. The analysis could, for example, determine how many questions the user answered correctly, if the knowledge teaching included questions to be answered by the user. If the knowledge teaching comprised information in the form of tips or quotes, the analysis could seek to determine how useful the user thought the information to be, based on the user provided feedback.

Decision step 216, in view of the user provided feedback. The feedback analysis of step 214 may also be placed in a personal education profile of the user, for later use to incentivize the user. This could pertain to results showing the users yearly education or individual development.

Decision step 216 determines whether feedback from users should be used to update the user's profile at step 204. If the decision is affirmative, the user profile is updated, and otherwise the method of FIG. 2 is ended.

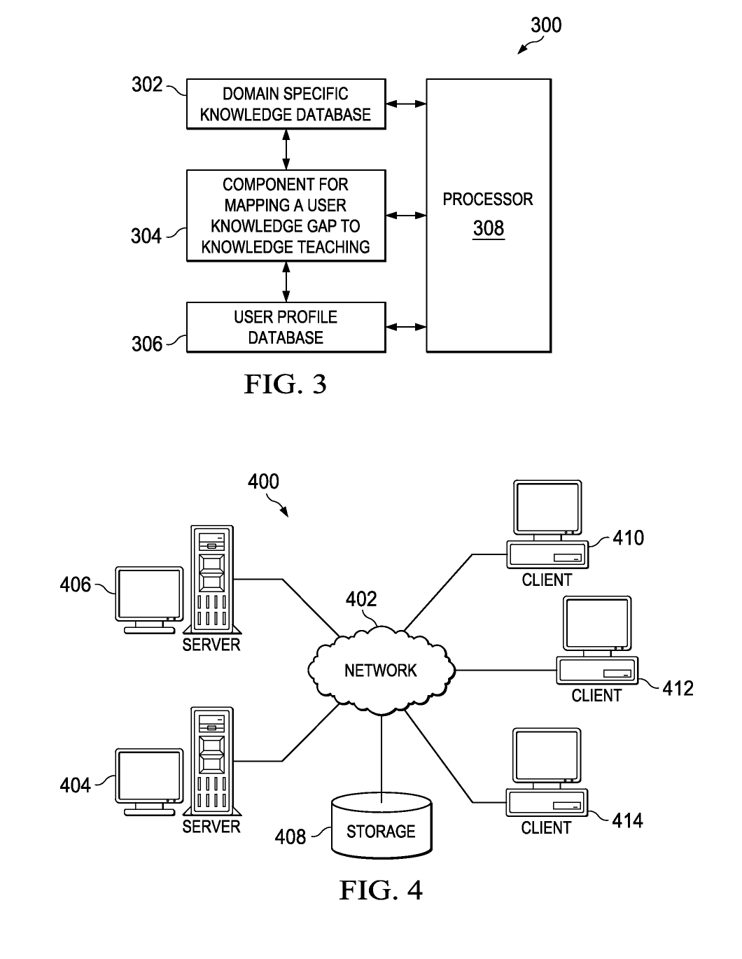

Referring to FIG. 3, there is shown a simplified configuration 300 of elements or components, for carrying out some or all steps of embodiments of the invention. These include the embodiments of FIGS. 1 and 2. Configuration 300 includes domain specific knowledge database 302, which contains information that can be used to generate a library of knowledge teachings as described above.

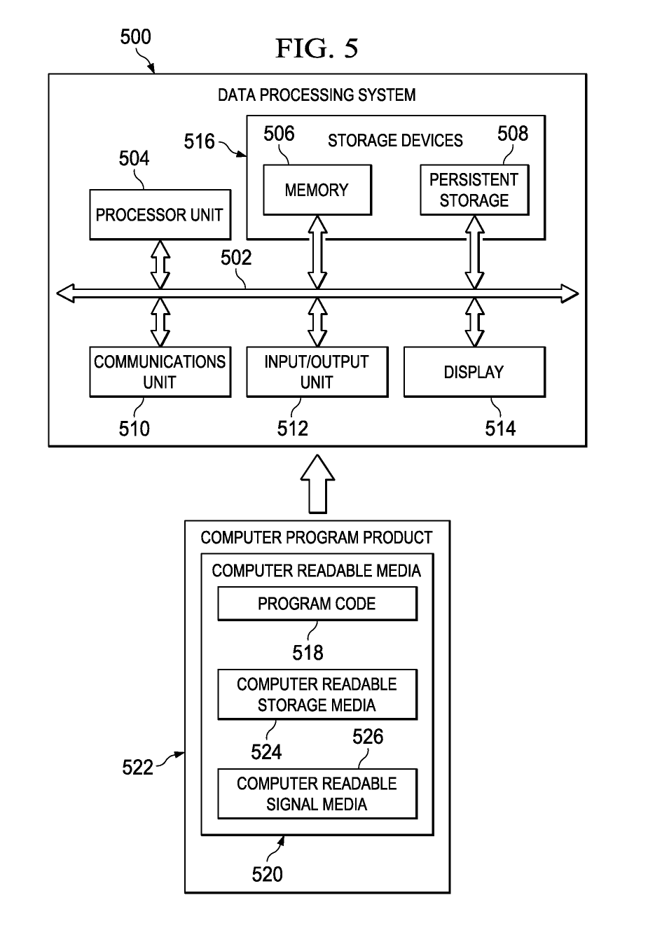

Configuration 300 further includes component 304 for mapping user knowledge gaps to respectively corresponding knowledge teachings, and a user profile database 306 for storing respective user profiles. For a given embodiment of the invention, processor 308 coordinates activities of domain specific knowledge database 302, component 304, and component 306 with one another as required, and also with other components not shown in FIG. 3. These include components such as those described hereinafter in further detail, in connection with FIGS. 4 and 5.

FIG. 4 is a pictorial representation of a network of data processing systems in which illustrative embodiments of the invention may be implemented. Network data processing system 400 is a network of computers in which the illustrative embodiments may be implemented. Network data processing system 400 contains network 402, which is the medium used to provide communications links between various devices and computers connected together within network data processing system 400. Network 402 may include connections, such as wire, wireless communication links, or fiber optic cables.

In the depicted example, server computer 404 and server computer 406 connect to network 402 along with storage unit 408. In addition, client computers 410, 412, and 414 connect to network 402. Client computers 410, 412, and 414 may be, for example, personal computers or network computers. In the depicted example, server computer 404 provides information, such as boot files, operating system images, and applications to client computers 410, 412, and 414. Client computers 410, 412, and 414 are clients to server computer 404 in this example. Network data processing system 400 may include additional server computers, client computers, and other devices not shown.

Program code located in network data processing system 400 may be stored on a computer-recordable storage medium and downloaded to a data processing system or other device for use. For example, program code may be stored on a computer-recordable storage medium on server computer 404 and downloaded to client computer 410 over network 402 for use on client computer 410.

In the depicted example, network data processing system 400 is the Internet with network 402 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 400 also may be implemented as a number of different types of networks, such as, for example, an intranet, a local area network (LAN), or a wide area network (WAN). FIG. 4 is intended as an example, and not as an architectural limitation for the different illustrative embodiments.

Turning now to FIG. 5, an illustration of a data processing system is depicted in accordance with an illustrative embodiment. In this illustrative example, data processing system 500 includes communications fabric 502, which provides communications between processor unit 504, memory 506, persistent storage 508, communications unit 510, input/output (I/O) unit 512, and display 514.

Processor unit 504 serves to process instructions for software that may be loaded into memory 506. Processor unit 504 may be a number of processors, a multi-processor core, or some other type of processor, depending on the particular implementation. “A number,” as used herein with reference to an item, means one or more items. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device is any piece of hardware that is capable of storing information, such as, for example, without limitation, data, program code in functional form, and/or other suitable information either on a temporary basis and/or a permanent basis. Storage devices 516 may also be referred to as computer readable storage devices in these examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these examples, provides for communications with other data processing systems or devices. In these examples, communications unit 510 is a network interface card. Communications unit 510 may provide communications through the use of either or both physical and wireless communications links.

Input/output unit 512 allows for input and output of data with other devices that may be connected to data processing system 500. For example, input/output unit 512 may provide a connection for user input through a keyboard, a mouse, and/or some other suitable input device. Further, input/output unit 512 may send output to a printer. Display 514 provides a mechanism to display information to a user.

Instructions for the operating system, applications, and/or programs may be located in storage devices 516, which are in communication with processor unit 504 through communications fabric 502. In these illustrative examples, the instructions are in a functional form on persistent storage 508. These instructions may be loaded into memory 506 for processing by processor unit 504. The processes of the different embodiments may be performed by processor unit 504 using computer-implemented instructions, which may be located in a memory, such as memory 506.

These instructions are referred to as program code, computer usable program code, or computer readable program code that may be read and processed by a processor in processor unit 504. The program code in the different embodiments may be embodied on different physical or computer readable storage media, such as memory 506 or persistent storage 508.

Program code 518 is located in a functional form on computer readable media 520 that is selectively removable and may be loaded onto or transferred to data processing system 500 for processing by processor unit 504. Program code 518 and computer readable media 520 form computer program product 522 in these examples. In one example, computer readable media 520 may be computer readable storage media 524 or computer readable signal media 526.

Computer readable storage media 524 may include, for example, an optical or magnetic disk that is inserted or placed into a drive or other device that is part of persistent storage 508 for transfer onto a storage device, such as a hard drive, that is part of persistent storage 508. Computer readable storage media 524 also may take the form of a persistent storage, such as a hard drive, a thumb drive, or a flash memory, that is connected to data processing system 500.

In some instances, computer readable storage media 524 may not be removable from data processing system 500. In these examples, computer readable storage media 524 is a physical or tangible storage device used to store program code 518 rather than a medium that propagates or transmits program code 518. Computer readable storage media 524 is also referred to as a computer readable tangible storage device or a computer readable physical storage device. In other words, computer readable storage media 524 is media that can be touched by a person.

Alternatively, program code 518 may be transferred to data processing system 500 using computer readable signal media 526. Computer readable signal media 526 may be, for example, a propagated data signal containing program code 518. For example, computer readable signal media 526 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 518 may be downloaded over a network to persistent storage 508 from another device or data processing system through computer readable signal media 526 for use within data processing system 500. For instance, program code stored in a computer readable storage medium in a server data processing system may be downloaded over a network from the server to data processing system 500. The data processing system providing program code 518 may be a server computer, a client computer, a remote data processing system, or some other device capable of storing and transmitting program code 518. For example, program code stored in the computer readable storage medium in data processing system 500 may be downloaded over a network from the remote data processing system to the computer readable storage medium in data processing system 500. Additionally, program code stored in the computer readable storage medium in the server computer may be downloaded over the network from the server computer to a computer readable storage medium in the remote data processing system.

Thus, illustrative embodiments of the present invention provide a computer implemented method, computer system, and computer program product for providing targeted and personalized education to prevent human errors.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method associated with a computer system activity comprising one or more tasks, wherein respective tasks are carried out by one or more users, and the method comprises the steps of:
furnishing a knowledge database with one or more knowledge teachings, wherein each knowledge teaching corresponds to one of the tasks;
implementing a procedure at selected intervals, to determine whether any user in a group of users lacks specified knowledge which is related to one of the tasks;
responsive to determining that a particular user lacks specified knowledge related to a particular task, presenting a knowledge teaching to the particular user which corresponds to the particular task, and includes at least some of the specified knowledge which the particular user has been determined to lack; and
selectively evaluating feedback sent from the particular user, in response to receiving the presented knowledge teaching.

2. The method of claim 1, wherein:
one or more specified criteria are used to select one or more users for the group of users.

3. The method of claim 2, wherein:
the specified criteria are selected from a group that includes at least one of the criterion that a user exceeded a specified number of errors of a particular type, the criterion that the user exceeded a specified number of unresolved service tickets, and the criterion that the user was found to be in noncompliance of a specified policy.

4. The method of claim 1, further comprising:
responsive to determining that a user lacks specified knowledge, carrying out a mapping process that searches the knowledge database, to locate a knowledge teaching that includes at least some of the specified knowledge which the user lacks.

5. The method of claim 1, wherein:
the knowledge teaching presented to the particular user has a form selected from a group of presentation forms, that includes at least a number of tips, a number of quotations of relevant information, and a number of questions to be answered by the particular user.

6. The method of claim 5, wherein:
the knowledge teaching is presented in the form of no more than two questions to be answered by the particular user, and feedback sent from the particular user comprises answers to the questions, wherein the answers are each evaluated to determine whether they are correct.

7. The method of claim 5, wherein:
the knowledge teaching is presented in the form of no more than two tips, or no more than two quotations, selectively, and feedback sent from the particular user provides an indication of how beneficial the particular user considered each tip or quotation to be.

8. The method of claim 1, wherein:
a given knowledge teaching is presented to a given user of the group of users, at an interval which is no less than one week following the last presentation of a knowledge teaching to the given user.

9. The method of claim 1, wherein:
a user profile is created for each user of the group of users.

10. The method of claim 9, wherein:
creating a profile for a given user includes assessing knowledge that the given user has in regard to a particular task, and selectively mining data sources of the user, wherein the data sources include one or more past service tickets of the given user that pertain to the particular task.

11. The method of claim 9, wherein:
feedback sent from the given user is used to selectively update the profile of the given user.

12. The method of claim 1, wherein:
providing a knowledge teaching that corresponds to a particular task comprises selectively processing data produced by one or more users who previously carried out the particular task successfully.

13. A computer program product executable in a recordable storage medium, and associated with a computer system activity comprising one or more tasks, wherein respective tasks are carried out by one or more users, and the computer program product comprises:
instructions for furnishing a knowledge database with one or more knowledge teachings, wherein each knowledge teaching corresponds to one of the tasks;
instructions for implementing a procedure at selected intervals, to determine whether any user in a group of users lacks specified knowledge which is related to one of the tasks;
instructions responsive to determining that a particular user lacks specified knowledge related to a particular task, for presenting a knowledge teaching to the particular user which corresponds to the particular task, and includes at least some of the specified knowledge which the particular user has been determined to lack; and
instructions for selectively evaluating feedback sent from the particular user, in response to receiving the presented knowledge teaching.

14. The computer program product of claim 13, further comprising:
instructions responsive to determining that a user lacks specified knowledge, for carrying out a mapping process that searches the knowledge database, to locate a knowledge teaching that includes at least some of the specified knowledge which the user lacks.

15. The computer program product of claim 13, wherein:
the knowledge teaching presented to the particular user has a form selected from a group of presentation forms, that includes at least a number of tips, a number of quotations of relevant information, and a number of questions to be answered by the particular user.

16. The computer program product of claim 15, wherein:
the knowledge teaching is presented in the form of no more than two questions to be answered by the particular user, and feedback sent from the particular user comprises answers to the questions, wherein the answers are each evaluated to determine whether they are correct.

17. The computer program product of claim 15, wherein:
the knowledge teaching is presented in the form of no more than two tips, or no more than two quotations, selectively, and feedback sent from the particular user provides an indication of how beneficial the particular user considered each tip or quotation to be.

18. The computer program product of claim 13, wherein:
a given knowledge teaching is presented to a given user of the group of users, at an interval which is no less than one week following the last presentation of a knowledge teaching to the given user.

19. The computer program product of claim 13, wherein:
a user profile is created for each user of the group of users.

20. A computer system associated with a computer related activity comprising one or more tasks, wherein respective tasks are carried out by one or more users, and the computer system comprises:
a bus;
a memory connected to the bus, wherein program code is stored on the memory; and
a processor unit connected to the bus, wherein the processor unit executes the program code:
to furnish a knowledge database with one or more knowledge teachings, wherein each knowledge teaching corresponds to one of the tasks;
to implement a procedure at selected intervals, to determine whether any user in a group of users lacks specified knowledge which is related to one or the tasks;
responsive to determining that a particular user lacks specified knowledge related to a particular task, to present a knowledge teaching to the particular user which corresponds to the particular task, and includes at least some of the specified knowledge which the particular user has been determined to lack; and
to selectively evaluate feedback sent from the particular user, in response to receiving the presented knowledge teaching.
